(19) United States
(12) Patent Application Publication
(10) Pub. No.: US 2015/0242039 A1
(43) Pub. Date: Aug. 27, 2015

(54) COMPENSATION OF DISTORTED DIGITAL INK STROKES CAUSED BY MOTION OF THE MOBILE DEVICE RECEIVING THE DIGITAL INK STROKES

(71) Applicant: Sony Corporation, Tokyo (JP)

(72) Inventors: Michael Chang, San Diego, CA (US); Jesse Gallup, San Marcos, CA (US)

(21) Appl. No.: 14/188,857

(22) Filed: Feb. 25, 2014

(51) Int. Cl. G06F 3/041; G06F 3/038; G06T 11/60; G06F 3/0354

(52) U.S. Cl. CPC G06F 3/0416; G06F 3/03545; G06F 3/038; G06T 11/60; G06T 2200/24

(57) ABSTRACT

A method for adapting a user interface to motion of the user interface includes receiving ink information generated by a user input such as a stylus. In some cases the input surface on which the user input is received may be a touch-screen display. The ink information is organized into corresponding ink strokes. Additionally, motion of the user interface is detected. One or more of the ink strokes that were organized from ink information generated at least in part while the motion was being detected is identified. The one or more identified ink strokes are adjusted to compensate for distortions thereto caused by the detected motion.

### BACKGROUND

Typical computer systems, especially computer systems using graphical user interfaces (GUIs), are optimized for accepting user input from one or more discrete input devices, such as a keyboard for entering text, and a pointing device, such as a mouse with one or more buttons, for operating the user interface. The ubiquitous keyboard and mouse interface provides for fast creation and modification of documents, spreadsheets, database fields, drawings, photos, and the like.

Recently, however, pen-based computing systems, such as tablet. PCs, personal digital assistants, and the like, have been increasing in popularity. In pen-based computing systems, user input advantageously may be introduced using an electronic “pen” or stylus (e.g., akin to writing with a conventional pen or pencil on a piece of paper). Indeed, in at least some pen-based computing systems, all user input is capable of being entered and manipulated using a pen, and the user interface is fully controllable using only the pen.

Many pen-based computing systems such as tablets and smart phones are true mobile devices that are utilized by users on the road for work, reading and entertainment. Their lightness, powerful processors, high quality screens and seamless Internet connections make these devices a much desired everyday companion.

However, usage conditions for train, car, airplane and ship passengers, in certain industrial settings, and in other unfavorable situations may be substantially different from the conditions of a comfortable office or home environment. Devices are subject to rattling, bumping, diving, dipping, jitter and other interferences that may occur at random times. Device motion, unwanted and uncontrolled by the user, may affect user interactions with devices and applications, resulting in a series of undesired consequences. In particular, distorted hand drawings and handwritten text in pen-enabled or finger-controlled touch applications may arise when unwanted motion occurs.

### SUMMARY

The system described herein provides various techniques for adapting user interfaces and user experiences on mobile devices to unfavorable usage conditions that cause unwanted movement of the mobile devices. Such unwanted movements may include, without limitation, shaking, jittering, jolting, vibrating and bumping. The mobile device may be equipped with motion sensors such as accelerometers and/or gyroscopes to detect the unwanted movements. When operating as an input device, the mobile device senses the position of the tip of a pen or other stylus as it moves across the input surface and provides this information to the device's processor.

To provide the user with visual feedback as the stylus moves, the computer typically displays “ink” (i.e., a path of pixels tracing the pen's movement) simulating the ink dropped by a real pen. If the mobile device has an integrated display screen, this electronic or digital ink is typically drawn directly beneath the tip of the moving stylus. Once the input signal from the motion sensors is analyzed, the system may modify one or more ink strokes that were created by the user while unwanted movement of the mobile device is in progress. More particularly, when unwanted movement of the mobile device occurs, the system modifies the ink strokes to compensate for the unwanted motion, thereby presenting an ink stroke that more closely resembles the ink stroke that the user intended. For instance, the ink stroke(s) may be repositioned and/or reshaped in response to the motion. As used herein, an ink stroke refers to ink data collected between the time the stylus is placed in contact with the input surface and the time the stylus is lifted from the tablet input screen.

### BRIEF DESCRIPTION OF THE DRAWINGS

FIG. 1 is a block diagram illustrating one example of a portable electronic device.

FIG. 2 is a top plan view of a mobile device such as the device shown in FIG. 1.

FIG. 3 is a schematic functional block diagram of the pertinent pen-based components of mobile device 100 (FIG. 1).

FIG. 4 is a top plan view of the mobile device shown in FIG. 2 illustrating the manner in which distorted ink stokes undergo modification to compensate for distortions caused by unwanted motion of the mobile device.

FIG. 5 is a flowchart illustrating one example of a method for adapting a user interface to motion of the user interface.

### DETAILED DESCRIPTION

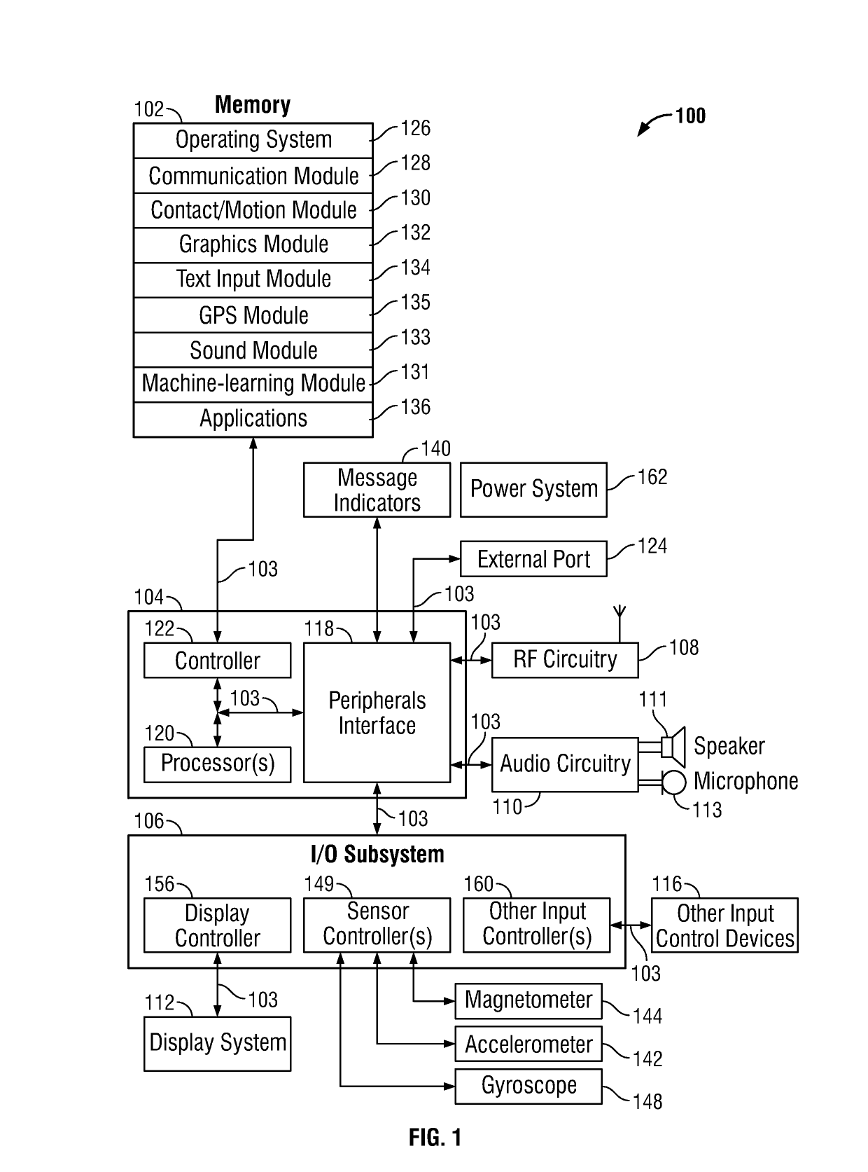

FIG. 1 is a block diagram illustrating one example of a portable electronic device. In some examples the device is a mobile communications device such as a wireless telephone that also contains other functions, such as PDA and/or music player functions. To that end the device may support any of a variety of applications, such as a telephone application, a video conferencing application, an e-mail application, an instant messaging application, a blogging application, a digital camera application, a digital video camera application, a web browsing application, a digital music player application, and/or a digital video player application. It may also support applications that make use of data concerning the spatial orientation of the device, including but not limited to augmented reality applications and the like. While the example in FIG. 1 is depicted as a mobile communications device, the computing device more generally may by any of a wide variety of different devices such as a laptop computer, a tablet computer, a smart phone and a netbook, for example.

The device 100 includes a memory unit 102 (which may include one or more computer readable storage media), a memory controller 122, one or more processors (CPU's) 120, a peripherals interface 118, RF circuitry 108, audio circuitry 110, a speaker 111, a microphone 113, display system 103, an input/output (I/O) subsystem 106, other input or control devices 116, and an external port 124. These components may communicate over one or more communication buses or signal lines. Along with the input or control devices 116, the speaker 111, microphone 113 and display system 103 form a user interface through which a user can enter and receive various types of information and can communicate with other individuals over communication networks using RF circuitry 108.

Memory unit 102 may include high-speed random access memory and non-volatile memory, such as one or more magnetic disk storage devices, flash memory devices, or other non-volatile solid-state memory devices. Access to memory unit 102 by other components of the device 100, such as the processor 120 and the peripherals interface 118, may be controlled by the memory controller 122. The peripherals interface 118 couples the input and output peripherals of the device to the processor 120 and memory unit 102. The one or more processors 120 run or execute various software programs and/or sets of instructions stored in memory unit 102 to perform various functions for the device 100 and to process data. In some examples the peripherals interface 118, the processor 120, and the memory controller 122 may be implemented on a single chip, such as a chip 104. In other examples they may be implemented on separate chips.

The RF (radio frequency) circuitry 108 includes a receiver and transmitter (e.g., a transceiver) for respectively receiving and sending RF signals, also called electromagnetic signals. The RF circuitry 108 converts electrical signals to/from electromagnetic signals and communicates with communications networks and other communications devices via the electromagnetic signals. The RF circuitry 108 may include well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. The RF circuitry 108 may communicate with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication may use any of a plurality of communications standards, protocols and technologies, including but not limited to Global System for Mobile Communications (GSM), Enhanced Data GSM Environment (EDGE), high-speed downlink packet access (HSDPA), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email, instant messaging, and/or Short Message Service (SMS)), or any other suitable communication protocol, including communication protocols not yet developed as of the filing date of this document.

The audio circuitry 110, the speaker 111, and the microphone 113 form a part of the user interface to provide an audio interface between a user and the device 100. The audio circuitry 110 receives audio data from the peripherals interface 118, converts the audio data to an electrical signal, and transmits the electrical signal to the speaker 111. The speaker 111 converts the electrical signal to human-audible sound waves. The audio circuitry 110 also receives electrical signals converted by the microphone 113 from audible signals (i.e., sound waves). The speaker 111 and microphone 113 are two examples of audio transducers that may be employed in the mobile communications device. The audio circuitry 110 converts the electrical signal to audio data and transmits the audio data to the peripherals interface 118 for processing. Audio data may be retrieved from and/or transmitted to memory unit 102 and/or the RF circuitry 108 by the peripherals interface 118. In some embodiments, the audio circuitry 110 also includes a headset jack (not shown). The headset jack provides an interface between the audio circuitry 110 and removable audio input/output peripherals, such as output-only headphones or a headset with both output (e.g., a headphone for one or both ears) and input (e.g., a microphone).

The I/O subsystem 106 couples input/output peripherals on the device 100, such as the display screen 112, sensor controller 149 and other input/control devices 116, to the peripherals interface 118. The I/O subsystem 106 may include a display controller 156 and one or more input controllers 160 for other input or control devices. The one or more input controllers 160 receive/send electrical signals from/to other input or control devices 116. The other input/control devices 116 may include physical buttons (e.g., push buttons, rocker buttons, etc.), dials, slider switches, joysticks, click wheels, and so forth. In some examples input controller(s) 160 may be coupled to any (or none) of the following: a keyboard, infrared port, USB port, and a pointer device such as a mouse.

The display screen 112 provides an input interface and an output interface between the device and a user. The display controller 156 receives and/or sends electrical signals from/to the display screen 112. The display screen 112 displays visual output to the user. The visual output may include graphics, text, icons, video, and any combination thereof (collectively termed “graphics”).

The display screen 112 will generally include a suitable display such as an OLED display, PLED display, active matrix liquid crystal display, passive matrix liquid crystal display, electrophoretic display, cholesteric liquid crystal display, polymer dispersed liquid crystal and nematic liquid crystal display. In some implementations the display screen 112 may be a touch-screen display.

The device 100 also includes one or more environmental sensors, which are in communication with peripherals interface 118 via sensor controllers 149. Such sensors may be used to capture the value of various environmental parameters and in this example, include two inertial sensors (a gyroscope 148 and accelerometer 142) and an optional magnetometer 144.

The device 100 also includes a power system 162 for powering the various components. The power system 162 may include a portable power supply (e.g., battery) and components used to receive power from an alternating current (AC) source, a power management system, a recharging system, a power failure detection circuit, a power converter or inverter and any other components associated with the generation, management and distribution of power in portable devices.

In some embodiments, the software components stored in memory unit 102 may include an operating system 126, a communication module (or set of instructions) 128, a contact/motion module (or set of instructions) 130, a graphics module (or set of instructions) 132, a text input module (or set of instructions) 134, a Global Positioning System (GPS) module (or set of instructions) 135, a sound module 133 (or set of instructions) and applications (or set of instructions) 136.

The operating system 126 (e.g., Darwin, RTXC, LINUX, UNIX, OS X, Microsoft WINDOWS®, Android or an embedded operating system such as VxWorks) includes various software components and/or drivers for controlling and managing general system tasks (e.g., memory management, storage device control, power management, etc.) and facilitates communication between various hardware and software components. The communication module (or set of instructions) 128 facilitates communication with other devices over one or more external ports 124 and also includes various software components for handling data received by the RF circuitry 108 and/or the external port 124 (e.g., Universal Serial Bus (USB), FIREWIRE, etc.).

The graphics module 132 includes various known software components for rendering and displaying graphics on the display screen 112, including components for changing the intensity of graphics that are displayed. As used herein, the term “graphics” includes any object that can be displayed to a user, including without limitation text, web pages, icons (such as user-interface objects including soft keys), digital images, videos, animations and the like. The text input module (or set of instructions) 134, which may be a component of graphics module 132, provides soft keyboards for entering text in various applications (e.g., contacts 137, e-mail 140, IM 141, blogging 142, browser 147, and any other application that needs text input).

The GPS module 135 determines the location of the device and may provide this information for use in various applications (e.g., applications that provide location-based services such as weather widgets, local yellow page widgets, and map/navigation widgets).

The applications 138 may include any combination of the following illustrative modules: a contacts module, a telephone module; a video conferencing module; an e-mail client module an instant messaging (IM) module; a blogging module; a camera module; an image management module; a video player module; a music player module; a browser module; a word processing module; a voice recognition module; a calendar module; widget modules, which may include a weather widget, stocks widget, calculator widget, alarm clock widget, dictionary widget, and other widgets obtained by the user, as well as user-created widgets. As described above, one or more of the applications may also employ spatial orientation data.

Each of the above identified modules and applications correspond to a set of instructions for performing one or more functions described above. These modules (i.e., sets of instructions) need not be implemented as separate software programs, procedures or modules, and thus various subsets of these modules may be combined or otherwise re-arranged in various embodiments. In some embodiments, memory unit 102 may store a subset of the modules and data structures identified above. Furthermore, memory unit 102 may store additional modules and data structures not described above.

It should be appreciated that the device 100 is only one example of a mobile communications device 100 and that the device 100 may have more or fewer components than shown, may combine two or more components, or a may have a different configuration or arrangement of components. The various components shown in FIG. 1 may be implemented in hardware, software or a combination of hardware and software, including one or more signal processing and/or application specific integrated circuits.

As mentioned above, in one implementation the inertial sensors include one or more rotational motion sensors such as gyroscope 148 and one or more linear motion sensors such as accelerometers 142. Gyroscopes 148 can sense or measure the angular velocity of the device 10 housing the gyroscopes 148. That is, gyroscopes output angular velocity in device coordinates. Gyroscopes having from one to three axes may be used, depending on the motion that is desired to be sensed in a particular embodiment, with a three-axis gyroscope being typical. Some gyroscopes may be dynamically activated or deactivated, for example to control power usage or adapt to motion processing needs. The accelerometer 142 can sense or measure the linear acceleration of the device 100 housing the accelerometer 142. An accelerometer typically operates by measuring the deflection of a small mass suspended by springs. The natural frequencies of the dynamics of the accelerometer are generally high and thus it responds quickly. The accelerometer outputs the sum of the linear acceleration in device coordinates and tilt due to gravity.

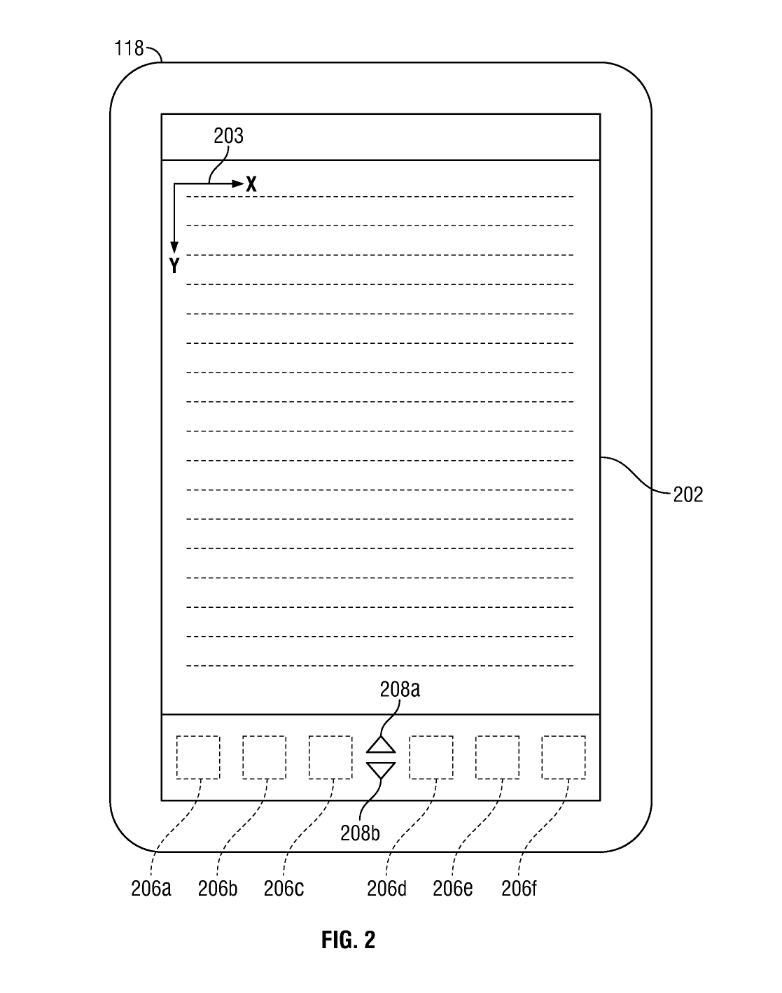

FIG. 2 is a top plan view of a mobile device such as the device 100 shown in FIG. 1. In this particular example the mobile device is configured as a tablet 118. In the illustrative embodiment, tablet 118 is configured to operate as both an input device and an output device. When operating as an output device, tablet 118 receives data from the processor 120 (FIG. 1) via I/O subsystem 106 and displays that data on a screen 202, such as a liquid crystal display (LCD) screen. The input device of tablet 118 may be a thin layer of sensing circuitry present either beneath the visible screen/tablet surface 202 or as part of a thin, clear membrane (not shown) overlying the screen 202 that is sensitive to the position of the pen 220 on its surface. An array of input buttons 206a-f may also be displayed. By tapping the buttons 206a-f with the pen 220, the user may cause various commands to be carried out by the tablet 118. Up and down scroll buttons 208a and 208b, which can be similarly activated by the pen 220, may also be provided.

In operation, a user can provide inputs to the computer system 100 by “writing” on the screen 202 of the tablet 118 with the pen 220. Alternatively, instead of pen 220 a finger or other stylus may be used. Information concerning the location of the pen 220 on the screen 202 relative to an x-y coordinate system 203 is sampled at a sampling rate (e.g., 100 times a second) and provided to the processor 120 via I/O subsystem 106 (see FIG. 1). Additional information, such as the orientation of the pen and the pressure of the pen on the screen 202, may also be provided to the processor 120.

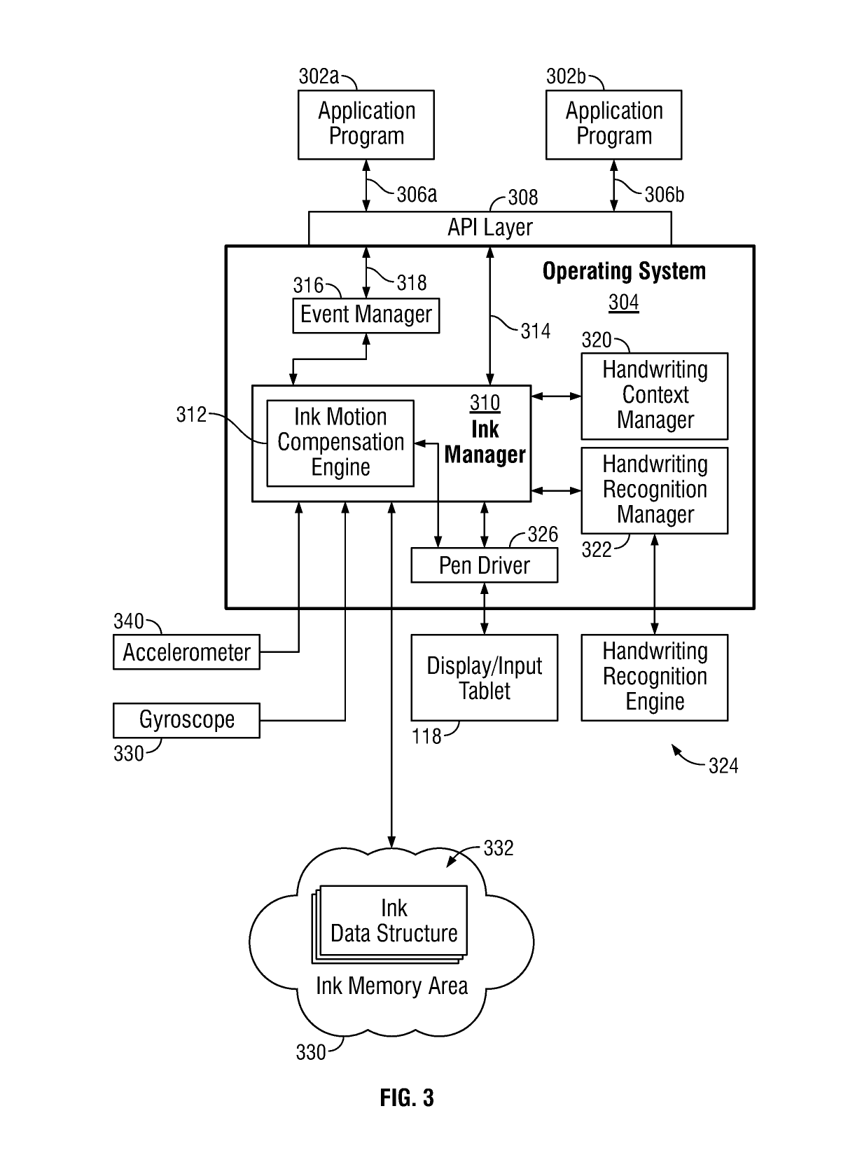

FIG. 3 is a schematic functional block diagram of the pertinent pen-based components of mobile device 100 (FIG. 1). These components may be implemented in hardware, software or a combination thereof. When implemented in software, the pen-based components generally include one or more application programs or processes, such as application programs 302a and 302b, and an operating system 304. The application programs 302a and 302b execute on the mobile device 100 and interact with the operating system 304 as shown by arrows 306a and 306b, through system calls or task commands of an application programming interface (API) layer 308, to control the operations of the mobile device 100. The operating system 304 includes an ink manager 310 having an ink motion compensation engine 312. The ink manager 310 is coupled to and provides part of the API layer 308 via arrow 314. It is also coupled to an event manager 316, which is itself coupled to the API layer 308 via arrow 318. The ink manager 310 may also be in communicating relationship with an optional handwriting context manager 320 and a handwriting recognition manager 322.

Installed onto the mobile device may be an optional handwriting recognition engine 324. The handwriting recognition manager 322 provides an interface or layer between the handwriting recognition engine 324 and its clients (e.g., the ink manager 310 or the application programs 302a, 302b themselves). In particular, the handwriting recognition manager 322 makes the existence of the handwriting recognition engine 324 known to the mobile device 100 and establishes a unique identifier for the handwriting recognition engine 324 and their clients. The input tablet 118 is typically coupled to the ink manager 310 by one or more drivers. Specifically, the ink manager 310 may receive ink information from a pen driver 326 to which it is coupled. The ink motion compensation engine 312 is coupled to the pen driver 326 for evaluating ink information received thereby as described below.

Mobile device 100 also includes inertial sensors and/or linear motion sensors such as gyroscope 330 and accelerometer 340. The ink manager 310 is coupled to the gyroscope 330 and accelerometer 340 and receives motion information therefrom.

In addition, the ink manager 310 is in communicating relationship directly or indirectly with an ink memory area 330 which may represent a portion of RAM incorporated in memory 102 (FIG. 1), which is allocated to the ink manager 310. Within the ink memory area 330, the ink manager 310 may establish and manipulate one or more ink data structures 332. It should be understood that the ink motion compensation engine 312 may be distributed between the ink manager 310 and the pen driver 326. It should also be understood that in some cases the pen driver 326 may be considered a part of the ink manager 310.

The ink manager 310, ink motion compensation engine 312 and pen driver 326 may comprise one or more software programs, such as software modules or libraries, pertaining to the methods described herein, that are resident on a computer readable media, such as mass memory or RAM, and executable by one or more processing elements, such as processor 120 (see FIG. 1). Other computer readable media, such as flash memory and CD-ROMs, may also be used to store the program instructions for execution. The ink manager 310, ink motion compensation engine 312 and pen driver 326 may also be implemented in hardware through a plurality of registers and combinational logic configured to produce sequential logic circuits and cooperating state machines. Those skilled in the art will recognize that various combinations of hardware and software components may also be employed.

The event manager 316, which may also constitute a set of software modules or libraries within the operating system 304, informs application programs 302a, 302b of hardware and software events by sending or returning event messages or records via API layer 308. For example, applications 302a, 302b may periodically issue a WaitNextEvent( ) function or system call to the event manager 316 to check to see if an event has occurred. In response, the event manager 316 returns the events, if any, which are pending for the requesting application. Each application program 302a and 302b may include an event handler for coordinating the request and receipt of events from the event manager 316. The ink manager 310 is in communicating relationship with the event manager 316 so that hardware and software occurrences for which the ink manager 310 is responsible (e.g., ink events) may be passed to the event manager 316 for forwarding to the appropriate application or process.

In operation, the ink manager 310 and/or pen driver 326 look for ink data as entered by the user. When the user inks, i.e., when the user places the pen 220 in contact with the tablet 118 and moves the pen 220 across its surface, ink information, such as ink data points, are generated by the tablet 118 and received and processed by the pen driver 326. This ink information is assumed to be targeted at the foreground application process. The top most open application or process, which is typically the application that is currently being operated by the user, is called the foreground process, while the other open applications and processes are referred to as background processes.

The pen driver 326 preferably collects and organizes the ink information (e.g., individual ink data points or pen locations) into corresponding ink strokes. More specifically, the pen driver 326 may begin storing the ink data points in a first buffer segment. When the ink information from the pen driver 326 indicates that the pen 220 (FIG. 2) has been lifted from the screen 202, the pen driver 326 stops storing the ink data points in the first buffer segment and initiates a second buffer segment for storing subsequent ink data points (i.e., when the pen 220 is again placed in contact with and moved across the screen 202) and so on. Accordingly, each buffer segment initialized by the pen driver 326 contains those ink data points corresponding to one ink stroke. To avoid generating new ink strokes when the pen 220 “skips” across the screen 202, as opposed to being lifted in order to begin a new stroke, the pen driver 326 may impose a short time out-of-contact with screen 202 requirement before concluding that the subsequent ink data points represent a new stroke.

The ink manager 310 may periodically poll the pen driver 326 to retrieve the ink strokes that have been gathered. Alternatively, the pen driver 326 will notify the ink manager 310, as part of an event-driven model, when it has a new ink stroke. The ink manager 310 stores the retrieved ink strokes within an ink data structure 332.

As previously mentioned, device motion, unwanted and uncontrolled by the user, may affect user interactions with the mobile device and its applications, resulting in distorted hand drawings and handwritten text when using pen-enabled applications. To address this problem the ink manager 310 receives motion information from the available motions sensors (e.g., gyroscope 330 and accelerometer 340 in FIG. 3). The motion information is provided, in turn, to the ink motion compensation engine 313. In one implementation the motion information will include the magnitude, direction and duration of any acceleration that the mobile device undergoes.

When the ink motion compensation engine 313 is made aware of the acceleration, it will retrieve any ink strokes that were created and stored in the buffer segments when the acceleration was occurring and modify them as necessary to compensate for distortions to the ink strokes that were caused by the acceleration. For instance, if an unwanted motion arises from a force applied to the left side of the mobile device (i.e. in the x-direction) while the pen 220 is in contact with the screen 202, the unwanted motion may cause the device to capture an ink stroke that is distorted relative to the undistorted ink stroke that the user intended to write or draw. To compensate for this unintended ink stroke, the ink motion compensation engine 313 will modify the ink stroke so that it corresponds more closely to what the user actually intended.

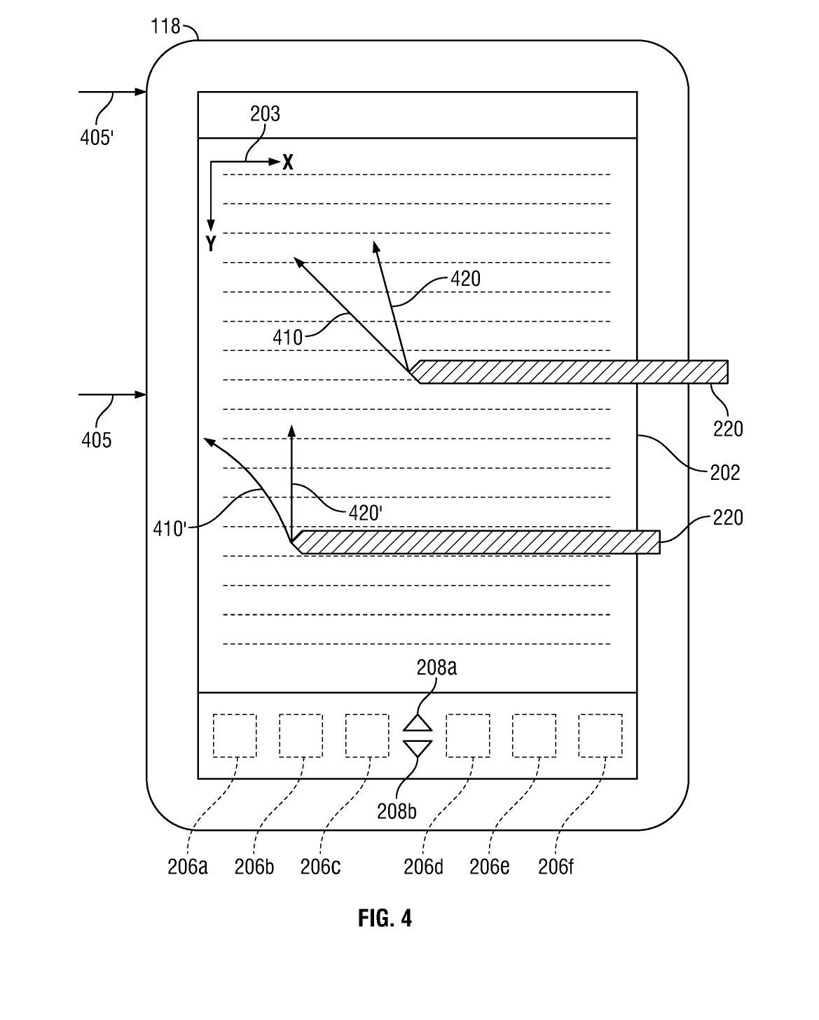

For example, if the device shown in FIG. 4 captures the unwanted ink stroke 410 shown in FIG. 4 while a force 405 (e.g., a “bump”) is applied to the left side of the mobile device (i.e., in the x-direction), the ink motion compensation engine 313 will modify the ink stroke so that it appears as undistorted ink stroke 420. Undistorted ink stroke 420 represents the ink stroke that would have been received on the screen 202 if the force 405 had not been applied to the mobile device.

As yet another example if the force 405′ shown in FIG. 4 is applied to the mobile device, causing the mobile device to undergo both linear and rotational motion, the unwanted ink stroke 410′ will appear on the screen 202 and be received by the pen driver 326. Using the motion information obtained from the both the mobile device's gyroscope and accelerometer, the ink compensation engine adjusts the unwanted ink stroke 410′ so that it is reconfigured or reshaped, appearing as undistorted ink stroke 420′.

Of course, the examples presented above are simple examples presented for the purpose of illustration only. Those of ordinary skill in the art will recognize that the mobile device may undergo a wide range of more complex motions, caused by the application of one or more simultaneous forces, which lead to a wide variety of differently shaped ink strokes that are to be reshaped and/or repositioned in a substantially more complex manner than is represented by these examples.

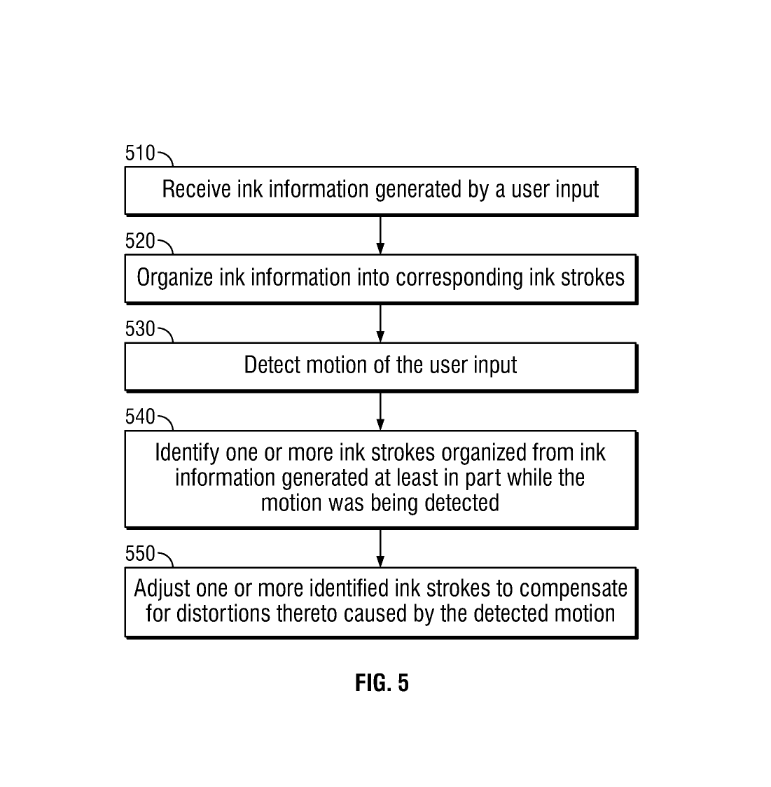

FIG. 5 is a flowchart illustrating one example of a method for adapting a user interface to motion of the user interface. The method begins in step 510 by capturing or otherwise receiving ink information generated by a user input such as a stylus. In some cases the input surface on which the user input is received may be a touch-screen display. The ink information is organized into corresponding ink strokes in step 520. Motion of the user interface is detected in step 530. One or more of the ink strokes that were organized from ink information generated at least in part while the motion was being detected is identified in step 540. Finally, in step 550, the one or more identified ink strokes are adjusted to compensate for distortions thereto caused by the detected motion.

In the foregoing specification, the invention is described with reference to specific embodiments thereof, but those skilled in the art will recognize that the invention is not limited thereto. Various features and aspects of the above-described invention may be used individually or jointly. Further, the invention can be utilized in any number of environments and applications beyond those described herein without departing from the broader spirit and scope of the specification. The specification and drawings are, accordingly, to be regarded as illustrative rather than restrictive.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Moreover, as disclosed herein, the term “memory” or “memory unit” may represent one or more devices for storing data, including read-only memory (ROM), random access memory (RAM), magnetic RAM, core memory, magnetic disk storage mediums, optical storage mediums, flash memory devices, or other computer-readable mediums for storing information. The term “computer-readable medium” includes, but is not limited to, portable or fixed storage devices, optical storage devices, wireless channels, a sim card, other smart cards, and various other mediums capable of storing, containing, or carrying instructions or data.

Furthermore, embodiments may be implemented by hardware, software, firmware, middleware, microcode, hardware description languages, or any combination thereof. When implemented in software, firmware, middleware, or microcode, the program code or code segments to perform the necessary tasks may be stored in a computer-readable medium such as a storage medium. Processors may perform the necessary tasks.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

1. A method for adapting a user interface to motion of the user interface, comprising:
receiving ink information generated by a user input;
organizing the ink information into corresponding ink strokes. detecting motion of the user interface;
identifying one or more ink strokes that were organized from ink information generated at least in part while the motion was being detected; and
adjusting the one or more identified ink strokes to compensate for distortions thereto caused by the detected motion.

2. The method of claim 1, wherein detecting motion of the user interface includes detecting linear acceleration of the user interface.

3. The method of claim 1, wherein detecting motion of the user interface includes detecting angular velocity of the user interface.

4. The method of claim 1, wherein the ink information includes a plurality of pixel locations on the user interface contacted by the user input, the adjusting of the one or more identified ink strokes further comprises reassigning pixel locations to ink information included in the one or more identified ink strokes

5. The method of claim 4, wherein the reassigning includes removing selected pixel locations from the ink information in the one or more identified ink strokes and replacing at least one of the selected pixel locations with at least one replacement pixel location different from the at least one selected pixel location.

6. The method of claim 1, wherein the user interface includes a touch-screen display.

7. The method of claim 1, wherein adjusting the one or more identified ink strokes includes supplementing the adjustment of the one or more identified ink strokes using handwriting recognition.

8. The method of claim 1, wherein the user interface is incorporated into a mobile communication device.

9. The method of claim 1, wherein the user interface is incorporated into a transportation vehicle.

10. The method of claim 9, wherein the transportation vehicle is selected from the group consisting of an automotive vehicle, boat, train and aircraft.

11. The method of claim 1, wherein adjusting the one or more identified ink strokes includes repositioning and/or reshaping one or more of the identified ink strokes on the user interface.

12. An apparatus comprising:
a pen-based user interface;
at least one motion detector for detecting motion of the pen-based user interface;
a pen driver coupled to the pen-based user interface and configured to collect and organize received ink information into ink strokes; and
an ink manager coupled to the pen driver for receiving the ink strokes, the ink manager having an ink motion compensation engine configured to adjust one or more distorted ink strokes to compensate for distortions thereto caused by the detected motion, the distorted ink strokes being ink strokes organized from ink information received by the pen-based user interface while the motion of the pen-based user interface is detected.

13. The apparatus of claim 12, further comprising an ink memory area organized into one or more ink data structures, wherein the ink manager stores the ink strokes in at least one of the ink data structures and, in response to receiving motion information from the at least one motion detector, retrieves the one or more distorted ink strokes from the one or more ink data structures for adjustment by the ink manager motion compensation engine.

14. The apparatus of claim 12, wherein the motion detector includes a linear accelerometer.

15. The apparatus of claim 12, wherein the motion detector includes an angular velocity detector

16. The apparatus of claim 12, wherein the ink information includes a plurality of pixel locations on the user interface contacted by the user input, the ink motion compensation engine adjusting the one or more identified ink strokes by reassigning pixel locations to ink information included in the one or more identified ink strokes

17. The apparatus of claim 16, wherein the ink motion compensation engine reassigns the pixel locations by removing selected pixel locations from the ink information in the one or more identified ink strokes and replacing at least one of the selected pixel locations with at least one replacement pixel location different from the at least one selected pixel location.

18. The apparatus of claim 12, wherein the user interface includes a touch-screen display.

19. The apparatus of claim 12, wherein adjusting the one or more identified ink strokes includes supplementing the adjustment of the one or more identified ink strokes using handwriting recognition.

20. The apparatus of claim 12, wherein the user interface is incorporated into a mobile communication device.

21. The apparatus of claim 12, wherein the user interface is incorporated into a transportation vehicle.

22. The apparatus of claim 21, wherein the transportation vehicle is selected from the group consisting of an automotive vehicle, boat, train and aircraft.

23. The apparatus of claim 12, wherein ink motion compensation engine adjusts the one or more identified ink strokes by repositioning and/or reconfiguring one or more of the identified ink strokes on the user interface.
